(19) United States
(12) Patent Application Publication
(10) Pub. No.: US 2006/0209775 A1
(43) Pub. Date: Sep. 21, 2006

(54) SIP message and processing method thereof in mobile communication system

(75) Inventors: Chan-Seok Lim, Gyeonggi-do (KR); Sung-Bum Choi, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/373,240

(22) Filed: Mar. 13, 2006

(30) Foreign Application Priority Data
Mar. 15, 2005 (KR) 10-2005-021589

(51) Int. Cl. H04Q 7/24; H04L 12/28

(52) U.S. Cl. 370/338; 370/351

(57) ABSTRACT

A method of defining and processing an SIP message of a binary format so as to shorten the call setting time between a server and a terminal which has not acquired a traffic channel and to thus reduce the amount of traffic. The method may comprise a step in which a calling terminal sends an invite message (INVITE) of a binary SIP message format to a server through an access channel; a step in which the server decodes the invite message into a text-based SIP message to check the message; a step in which the server converts the text-based SIP message into an invite message of a binary SIP message and sending the message to a destination terminal through an access channel; and a step in which the destination terminal sends the calling terminal a response message with respect to the invite message.

### BACKGROUND OF THE INVENTION

1. Field of the Invention

The present invention relates to a session initiation protocol (SIP) message, and particularly, to a SIP message and its processing method in a mobile communication system.

2. Description of the Background Art

A session initiation protocol (SIP) is a text-based protocol such as hypertext transfer protocol (HTTP), and is based on a client-server architecture in which as clients start to make calls, a server responds to the calls. The SIP is easy to access an existing Internet environment because it is an Internet standard and is conveniently implemented because it is text-based, and services can be easily added thereto. Due to such advantages, SIP features are being applied to VoIP (Voice over IP) services in wireless communications.

In a wireless communications system, the SIP may be used in implementing not only a voice communication service, but also an e-mail service, an instant message service, a PTT (Push to Talk) service, and the like by using an identifier having an address system similar to that of an e-mail message.

To access a call through SIP, a client sends an invite message (hereinafter, referred to as an INVITE) including session information for exchanging information about himself with multimedia data to a destination client via a server, and the destination client notifies as to whether to accept the invitation by using a response message. Here, the SIP message such as the INVITE and the response message are encoded as a text based message that can be read.

When a client requests a call from a server in the general wireless communications system, the client sends information related to a call, a response, a command and registration through an access channel, and sends a voice message and a multimedia message through a traffic channel.

However, because the SIP message that the client sends to the server is text-based in the SIP-based wireless communication system, it has a large size, and the SIP message is sent through the traffic channel. Namely, for a terminal to make an attempt to set a call or to perform a subscription refresh procedure, a process of setting the traffic channel should first be performed.

FIG. 1 is a signal flow chart showing a process of setting a call between clients both of which are in a dormant state in the related art SIP-based wireless communications system, and it is assumed that both a calling client (sender) and a destination client (receiver) are in a dormant state.

A client in the dormant state should obtain a traffic channel in order to send a message (i.e., INVITE) for setting a call. Accordingly, the calling client starts to establish the traffic channel to send the INVITE, and sends the INVITE to the destination client through the corresponding traffic channel after obtaining the traffic channel.

The destination client having received the INVITE starts to establish a traffic channel to send a response message (200 OK) with respect to the INVITE to the calling client. If the traffic channel is established, the response message is sent to the destination client through the corresponding traffic channel.

The calling client having received the response message with respect to the INVITE sends to the destination client an acknowledge message (ACK) with respect to the corresponding response message.

Here, the call setting time refers to the time consumed by the calling client to establish a traffic channel, to receive a response message with respect to the INVITE, and to send the acknowledge message (ACK) to the destination client.

As described so far, when the client which has not obtained the traffic channel in the related art SIP-based wireless communications system, the time consumed in obtaining the traffic channel is included in the call setting time. For this reason, the entire call setting time is lengthened, undesirably.

Also, in the related art SIP-based wireless communications system, the traffic channel should be periodically obtained for the purpose of registration or subscription refreshing, which disadvantageously increases data traffic due to a traffic channel acquisition procedure.

### SUMMARY OF THE INVENTION

Therefore, an object of the present invention is to provide an SIP message and its processing method in a wireless communications system capable of shortening the call setting time between a terminal and a server, and reducing the traffic when a traffic channel is not obtained.

To achieve these and other advantages and in accordance with the purpose of the present invention, as embodied and broadly described herein, there is provided a session initiation protocol (SIP) message in a wireless communications system in a system in which a text-based SIP message is sent and received through a traffic channel, wherein a message sent between a server and a terminal that has not obtained the traffic channel is a binary SIP message obtained by coding a text-based SIP message into binary codes.

To achieve these and other advantages and in accordance with the purpose of the present invention, as embodied and broadly described herein, there is provided a method for processing an SIP message in a wireless communications system, comprising: a step in which a terminal that has not obtained a traffic channel sends a binary SIP message to a server through an access channel; and a step in which the server decodes the binary SIP message into a text-based SIP message.

To achieve these and other advantages and in accordance with the purpose of the present invention, as embodied and broadly described herein, there is provided a method for processing an SIP message in a wireless communications system, comprising: a step in which a calling terminal sends an invite message (INVITE) of a binary SIP message format to a server through an access channel; a step in which the server decodes the invite message into a text-based SIP message and checks the message; a step in which the server converts the text-based SIP message into an invite message of a binary SIP message format and sending the message to a destination terminal through an access channel; and a step in which the destination terminal sends the calling terminal a response message with respect to the invite message.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a signal flow chart showing a process of setting a call between clients, which are in a dormant state, in the related art SIP-based wireless communications system;

FIG. 2 is a block diagram showing a structure of a wireless communications system in accordance with the present invention;

FIG. 3 is a signal flow chart showing a process of setting a call between terminals, which are in a dormant state, in the wireless communications system;

FIG. 4 is an exemplary view showing a format of a binary SIP message in accordance with the present invention;

FIG. 5 is an exemplary view showing an embodiment of an MT of the binary SIP message;

FIG. 6 is an exemplary view showing an embodiment of an AT of the binary SIP message;

FIG. 7 is an exemplary view showing an embodiment of an ST of the binary SIP message;

FIG. 8 is a view showing a format of a ‘Via Branch’ decoded by the present invention;

FIG. 9 is a view showing a format of a ‘Call ID’ decoded by the present invention; and

FIGS. 10A to 10E are exemplary views showing embodiments of a binary SIP message in accordance with the present invention.

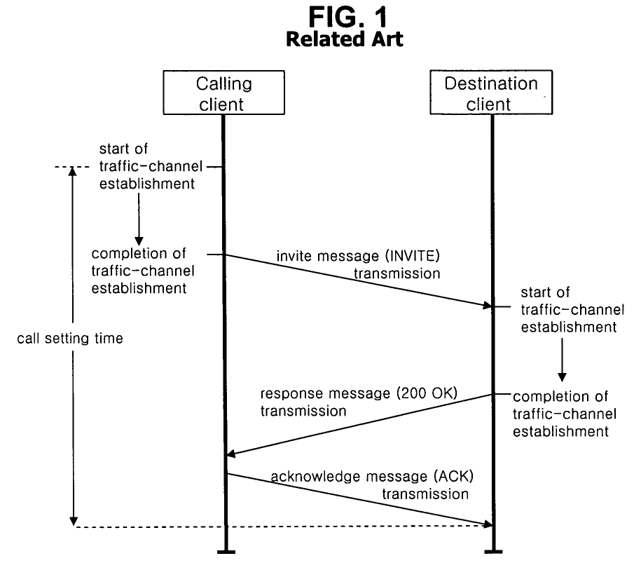

### DETAILED DESCRIPTION OF THE INVENTION

Reference will now be made in detail to some embodiments of the present invention, examples of which are illustrated in the accompanying drawings.

The present invention defines a format of a new SIP message such that an SIP message for call setting can be sent through an access channel, not through a traffic channel, when a client which has not obtained the traffic channel attempts to set a call. Here, the SIP message is encoded as binary codes, not as text, and this message is called a binary SIP message.

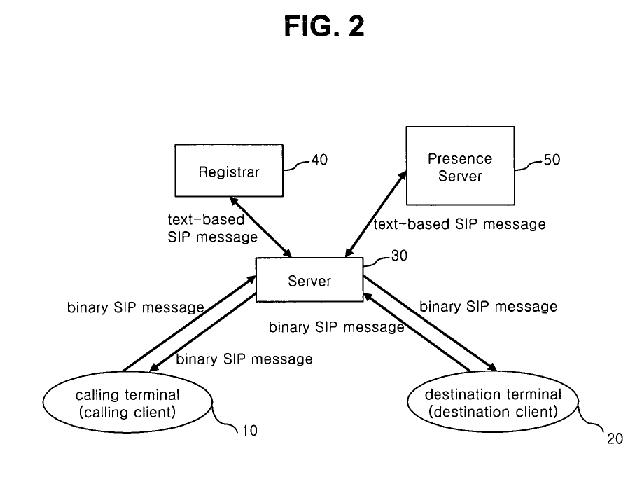

FIG. 2 is a block diagram showing a structure of the wireless communications system in accordance with the present invention. The binary SIP message is sent via a wireless communication interface between a calling terminal (calling client) 10 and a server 30, and between the server 30 and a destination terminal (destination client) 20. A text-based SIP message is sent via a wired communication interface between the server 30 and the register 40 or between the server 30 and a presence server 50.

When the calling terminal 10 which has not obtained the traffic channel (i.e., a dormant channel) attempts to set a call, the calling terminal 10 and the destination terminal 20 send the binary SIP message to the server 30 through the access channel.

The server 30 decodes the binary SIP message, which has been sent from the calling terminal 10 or the destination terminal 20 through the access channel, into a text-based SIP message and checks the message. At certain occasions, the server 30 sends the text-based SIP message to the register 40 or the presence server 50, and encodes the text-based SIP message into a binary SIP message, and then sends the binary SIP message to the destination terminal 20 or the calling terminal 10 through the access channel.

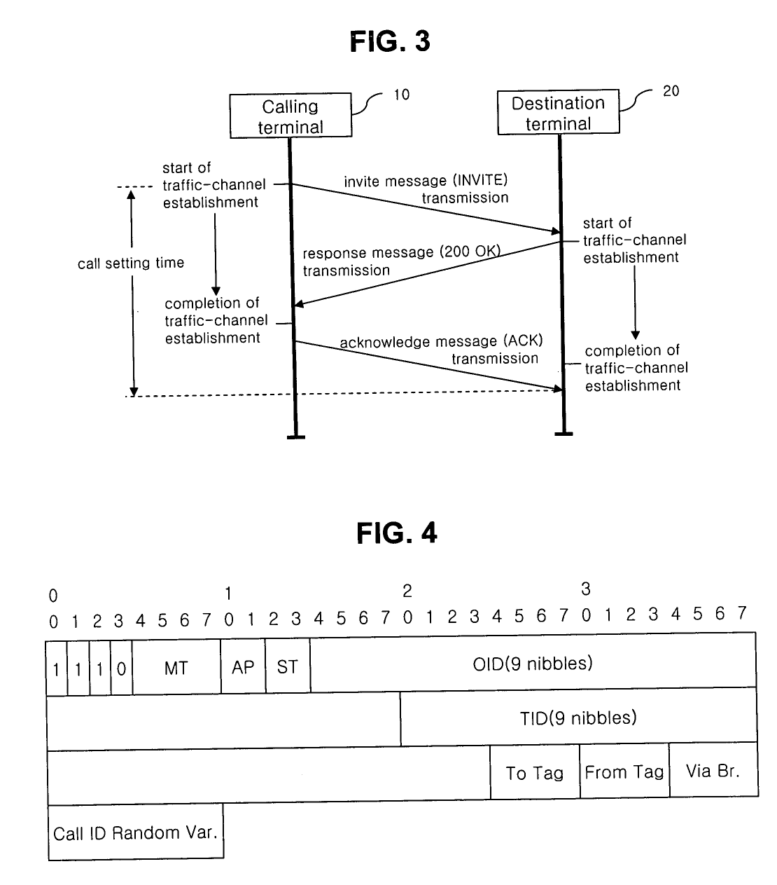

FIG. 3 is a signal flow chart showing a process of setting a call between terminals in the wireless communications system in accordance with the present invention. It is assumed that both the calling terminal 10 and the destination terminal 20 are in a dormant state.

When the calling terminal 10 in the dormant state attempts to set a call to the destination terminal 20, the calling terminal 10 sends a message (e.g., INVITE) having a binary SIP message format to the server 30 through an access channel and simultaneously, starts to set a traffic channel.

The server 30 decodes the binary SIP message sent from the calling terminal 10 into a text-based SIP message and then checks the message. Also, the server 30 encodes the text-based SIP message into a binary SIP message and sends the binary SIP message to the destination terminal 20 through the access channel.

After receiving an INVITE having the binary SIP message format from the server 30 through the access channel, the destination terminal 20 sends a response message (e.g., 200 OK) with respect to the INVITE and simultaneously starts to set a traffic channel. Here, the response message may also be a binary SIP message, and is sent to the server 30 through the access channel.

The server 30 decodes the response message sent from the destination terminal 20 into a text-based SIP message, then checks the message, and then encodes the text-based SIP message into a binary SIP message that is sent to the calling terminal 10 through the access channel.

The calling terminal 10 having received the response message with respect to the INVITE message sends an acknowledge message (ACK) with respect to the corresponding response message to the destination terminal 20 through the server 30. Here, the acknowledge message is a text-based SIP message sent through the traffic channel.

In the present invention, a process in which the calling terminal 10 and the destination terminal 20 set a traffic channel may be performed simultaneously together with a process of setting a call between the calling terminal 10 and the destination terminal 20. For this reason, the call setting time of the present invention refers to the time consumed to set a call through the access channel, and there is no need to include the time required for both the calling client and the destination client to set a traffic channel.

The general text-based SIP message necessarily includes a ‘Via’ field, a ‘To’ field, a ‘From’ field, a ‘Call-ID’ field and a ‘Cseq’ field, and each of the fields includes an SIP URL (Uniform Resource Locator), an identification value, or the like.

FIG. 4 shows an exemplary format of a binary SIP message in accordance with the present invention. The message shown in FIG. 4 is a binary SIP message expressed in a format encoded as a binary code such that the client can send the message to a server through an access channel. Here, the binary SIP message may include field values that are necessarily included in the text-based SIP message and are encoded into a binary code.

The binary SIP message may include a four-bit binary code for indicating that a corresponding message is a binary SIP message, an MT (Method Type) for indicating a type of the SIP message, an application ID (AP), a service type (ST), an originator ID (OID) for indicating an ID which allows an originator to be identified, and a terminator ID (TID) for indicating an ID which allows a terminator to be identified. Also, the binary SIP message may include a TO Tag for indicating a certain value allocated to the terminator ID, a From Tag for indicating a certain value allocated to the originator ID, a Via Branch (Via Br.) for indicating a certain parameter value for an SIP message sending path, and a Call ID. Here, each of field that respectively correspond to the MT, the application ID, the service type, the originator ID, the terminator ID, the To Tag, the From Tag, the Via Branch and the Call ID may include a binary code.

The four-bit binary code ‘1110’ is an exemplary value for representing a binary SIP message. This value may be defined as ‘1110’, but other values can also be used.

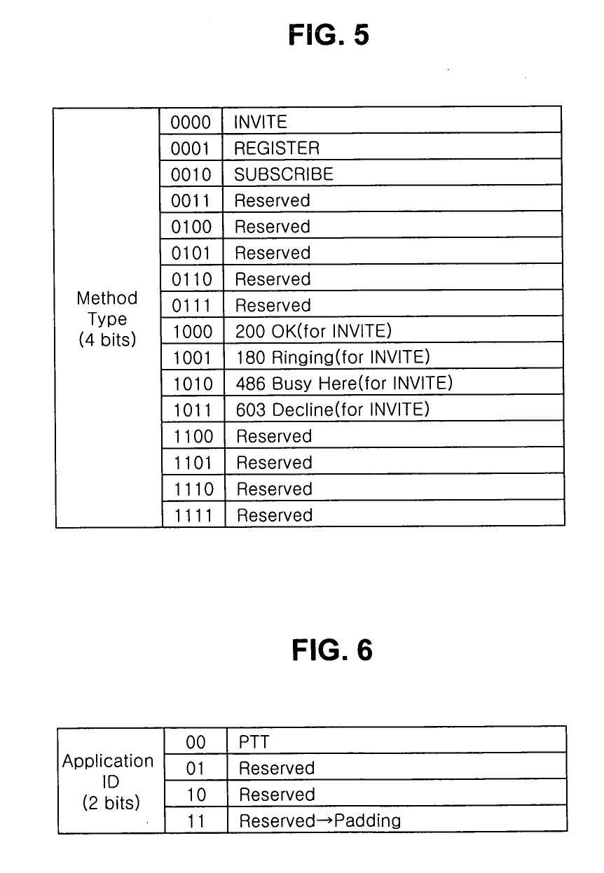

The MT refers to information about whether the SIP message is an INVITE message, a Register message, a SUBSCRIBE message, or the like, and is expressed as a four-bit binary code. FIG. 5 shows one embodiment of the MT.

For example, when the MT is ‘0000’, a corresponding binary SIP message is an INVITE message, when the MT is ‘0001’, the corresponding binary SIP message is a register message, and when the MT is ‘0010’, the corresponding message is a subscribe message. Also, various response messages with respect to the INVITE message are also defined, and other message types may be additionally set for code values which are not defined, respectively.

FIG. 6 shows one embodiment of the AT. The AT represents the application ID as a two-bit binary code. Here, ‘00’ may be a code value for representing the PTT service.

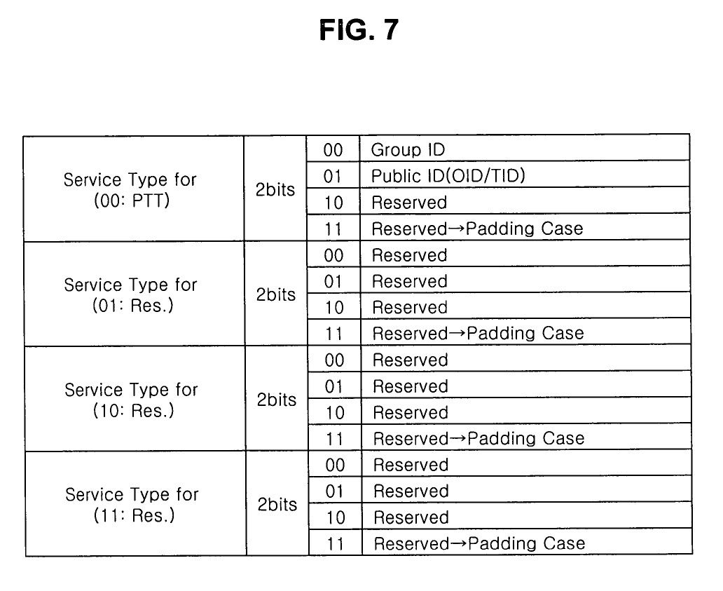

FIG. 7 shows an embodiment of the ST, and the ST is a two-bit binary code for defining a service type for the application ID.

If the application ID is ‘00’ and the ST is ‘00’, those code values may represent a PTT service for a group ID, and if the application ID is ‘00’ and the ST is ‘01’, those code values may represent a PTT service for an individual ID.

Fields corresponding to the Via Branch, the To Tag, the From Tag, the Call ID may have random values within ranges of 4-bit, 4-bit, 4-bit and 8-bit, respectively. The To Tag value is inputted by the destination terminal, and the From Tag value is a value inputted by the calling terminal. Here, the value inputted to the From Tag may be the same as that of a ‘Cseq’ field value. Accordingly, a value of the ‘Cseq’ field can be calculated from the From Tag even without separately forming a ‘Cseq’ field in the binary SIP message.

The originator ID may be a 36-bit field and may be expressed as a nine-digit identifier. Here, the four-bit portion may be a nibble for representing one identifier. When an originator of the binary SIP message employs CDMA (Code Division Multiple Access), the originator ID is an MDN (Mobile Directory Number) allotted to a corresponding terminal. Here, because each of MDNs allotted to domestic service providers has a 11-digit number beginning with ‘01’ which is a common number, the subsequent nine-digit number is the the originator ID. If the originator ID does not have nine digits, one or more dummy values (‘F’) may be padded from the very first empty space.

The terminator ID may be a 36-bit field, and may be expressed as a nine-digit identifier like the originator ID. If the terminator ID corresponds to a selective buddy call using CDMA, the terminator ID is an MDN allotted to a corresponding terminal. Namely, since each of MDNs allotted to domestic service providers is a 11-digit number beginning with ‘01’ which is a common number, the subsequent nine-digit number is the terminator ID. Here, in case of the selective buddy call, only a terminator ID corresponding to at least one buddy selected by the originator may be included in the binary SIP message.

If the terminator ID corresponds to a group call, as for the terminator ID, the group-ID bit is converted into 32-bit (8 nibble), and the first 4-bit portion (i.e., 1 nibble) is padded with ‘F’ bits, and then the group ID is included in the terminator ID of the binary SIP message. Here, the group ID may be defined within a nine-digit identifier.

An exemplary method according to the present invention for decoding such a binary SIP message into a text-based SIP message will now be described.

A terminal or a server having received the binary SIP message may create a field that is necessarily included in a header of a text-based SIP message, by using a value calculated from each field.

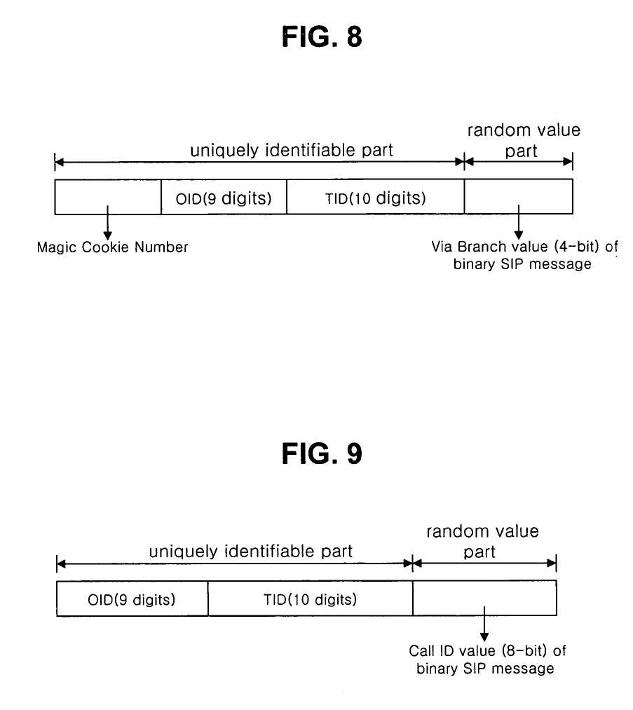

FIG. 8 shows an exemplary format of a ‘Via Branch’ decoded by the present invention, whereby the ‘Via Branch’ includes a uniquely identifiable part and a random value part.

The uniquely identifiable part is created according to a method that has been agreed upon between an originator and a terminator, and should be able to uniquely identify the current transaction. Accordingly, the uniquely identifiable part is generated by using a so-called magic cookie number, an originator ID and a terminator ID extracted from the binary SIP message. Here, a nine-digit number extracted from the SIP message may be used as the originator ID as it is, and the terminator ID has a total of 10 digits by padding an ‘F’ bit right in front of a 9-digit number extracted from the SIP message.

The random value part uses a value within a range of 4 bits stored in the Via Branch field of the binary SIP message as it is.

FIG. 9 shows an exemplary format of a ‘Call ID’ decoded by the present invention, whereby the Call ID includes a uniquely identifiable part and a random value part like the ‘Via Branch’.

The uniquely identifiable part may be generated by a method that has been agreed upon between an originator and a terminator, and should be able to uniquely identify the current transaction. Accordingly, the uniquely identifiable part may be generated by using an originator ID, and a terminator ID extracted from the binary SIP message. Namely, a nine-digit number extracted from the SIP message is used as the originator ID as it is, and the terminator ID has a total of ten digits by padding one ‘F’ bit right in front of a nine-digit number extracted from the binary SIP message.

The random value part uses a value within a range of 8 bits stored in the Call ID field of the binary SIP message as it is.

The originator ID and the terminator ID used in the ‘Via Branch’ and the ‘Call ID’ respectively have nine digits and ten digits by using the nine-digit numbers included in the binary SIP message, thereby decoding the binary SIP message into a text-based SIP message.

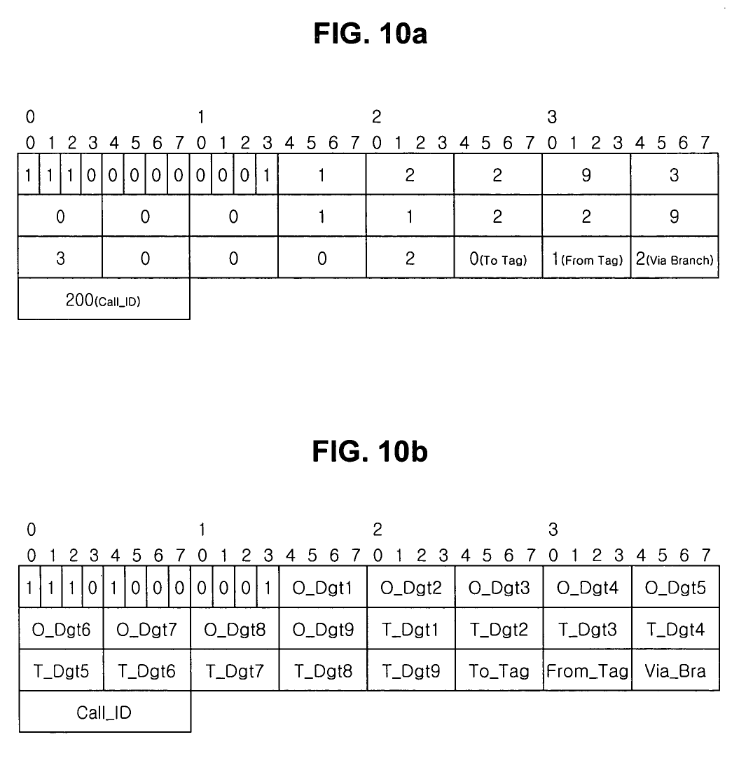

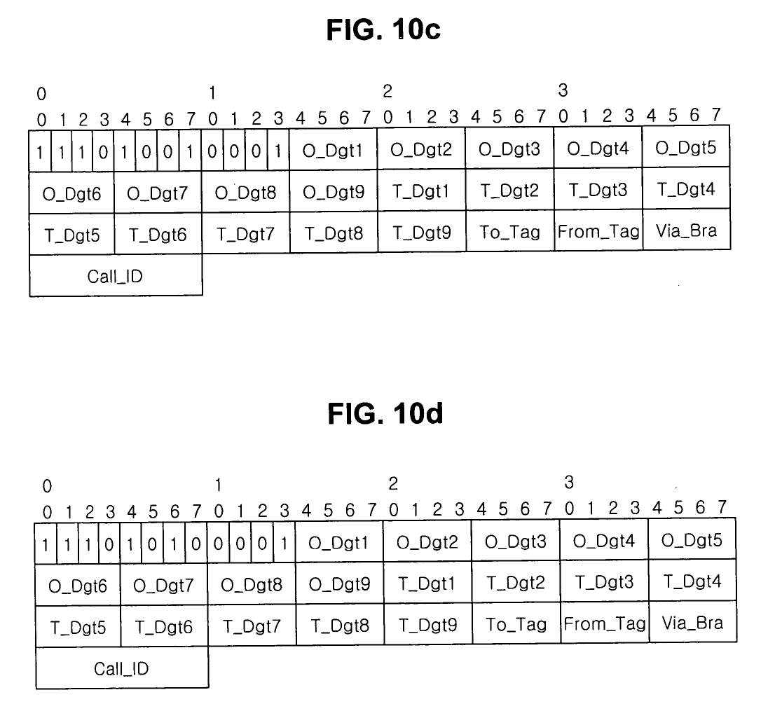

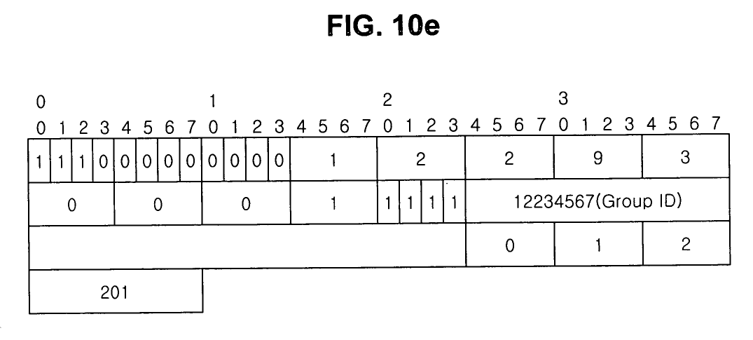

FIGS. 10A to 10E show exemplary embodiments of a binary SIP message in accordance with the present invention.

FIG. 10A shows an exemplary embodiment of an INVITE sent in case of a PTT service for an individual ID. As an example, an originator ID is ‘011-2293-0001’, and a terminator ID is ‘011-2293-0002’, a From Tag value is ‘1 (0001)’, a Via Branch value is ‘2 (0010)’ and a Call ID value is ‘200 (11001000)’.

FIGS. 10B to 10D show exemplary embodiments of ‘200 OK’, ‘180 Ringing’ and ‘486 Busy’ messages sent by a destination terminal as response messages to the received INVITE.

The destination terminal sets values of fields (except an MT field) and a To Tag field of the response message as the same values as those of a message sent by a calling terminal, then changes an MT field value according to a kind of response message, and inserts a 4-bit random value into the To Tag field. Namely, in case of a ‘200 OK’ message, the MT field is changed to ‘1000’, and the To Tag field, which was previously empty when being sent from the calling terminal, is padded with a random value. Also, in case of a ‘180 Ringing’ message, the MT field is changed to ‘1001’ and the To Tag field is padded with a random value. In case of a ‘486 Busy’ message, the MT field is changed to ‘1010’, the To Tag field is filled with a random value, and then the message is sent to the calling terminal.

FIG. 10E is an embodiment of an INVITE sent in case of a PTT service for a group ID. As an example, an originator ID is ‘011-2293-0001’, an terminator ID is ‘12234567’, and ‘F’ is padded right in front of the terminator ID number to form a nine-digit number. A From Tag value is ‘1 (0001)’, a Via Branch value is ‘2 (0010)’, and a Call ID is ‘201 (11001001)’. Here, the To Tag value is ‘0 (0000)’, which is empty.

As described so far, in the SIP message and its processing method in a wireless communications system in accordance with the present invention, when call setting is attempted through a terminal which has not yet obtained a traffic channel, a traffic channel for data sending is set and simultaneously, an INVITE of a binary SIP message format is sent through an access channel, thereby saving the time required in obtaining the traffic channel and thus reducing the call setting time by as much as the saved time. Accordingly, the entire call setting time can be reduced.

Also, in the SIP message and its processing method in the wireless communications system in accordance with the present invention, as a terminal periodically performs registration and subscription refresh procedures through the access channel, a procedure for acquiring the traffic channel to send a text-based SIP message may be omitted. Accordingly, the call setting time can be shortened, and also the amount of traffic can be reduced by sending a binary SIP message.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A session initiation protocol (SIP) message in a wireless communications system in a system in which a text-based SIP message is sent and received through a traffic channel, wherein a message sent between a server and a terminal that has not obtained the traffic channel is a binary SIP message obtained by coding a text-based SIP message to binary codes.

2. The SIP message of claim 1, wherein the binary SIP message is sent from a terminal to a server or from a server to a terminal through an access channel.

3. The SIP message of claim 1, wherein the binary SIP message comprises:
a four-bit field for indicating that a corresponding message is a binary SIP message;
a four-bit field for indicating a message type;
a two-bit field for indicating an application ID;
a two-bit field for indicating a service type;
a 36-bit field for indicating an identifier of an originator;
a 36-bit filed for indicating an identifier of a terminator; and
one or more fields including a random value.

4. The SIP message of claim 3, wherein the field including the random value comprises:
a To Tag field of four-bit;
a From Tag field of four-bit;
a Via Branch field of four-bit; and
a Call ID field of eight-bit.

5. The SIP message of claim 4, wherein the To Tag field is inputted by a destination terminal.

6. The SIP message of claim 4, wherein the From Tag field is inputted by an originator terminal.

7. The SIP message of claim 4, wherein the From Tag field uses the same value as a ‘Cseq’ value.

8. The SIP message of claim 3, wherein the originator identifying field and the terminator identifying field are expressed as nine-digit numbers, respectively, wherein four bits represents one digit.

9. The SIP message of claim 3, wherein the originator identifying field is a mobile directory number (MDN).

10. The SIP message of claim 9, wherein the originator identifying field comprises the mobile directory number excluding a provider common number.

11. The SIP message of claim 10, wherein if the mobile directory number excluding the provider common number is not a nine-digit number, ‘F’ is padded from the very first space.

12. The SIP message of claim 3, wherein the terminator identifying field is a mobile directory number (MDN) of a destination terminal in case of an individual ID.

13. The SIP message of claim 12, wherein the terminator identifying field is the mobile directory number excluding a provider common number.

14. The SIP message of claim 3, wherein, in case of a group ID, the terminator identifying field changes digits of the ID into eight digits and ‘F’ is padded right in front of the eight-digit number.

15. A method for processing an SIP message in a wireless communications system, comprising:
a step in which a terminal that has not obtained a traffic channel sends a binary SIP message to a server through an access channel; and
a step in which the server decodes the binary SIP message into a text-based SIP message.

16. The method of claim 15, wherein the step of decoding the binary SIP message further comprises:
coding the text-based SIP message into a binary SIP message and sending the binary SIP message to the other terminal.

17. The method of claim 16, wherein the binary SIP message is the same as the binary SIP message that the terminal has sent to the server.

18. The method of claim 15, wherein the step in which the terminal sends the binary SIP message further comprises:
sending the binary SIP message and simultaneously starting to set a traffic channel.

19. The method of claim 15, wherein in the step of decoding the binary SIP message, a Via Branch field and a Call ID field are generated by combining fields of the binary SIP message.

20. The method of claim 19, wherein the Via Branch field and the Call ID field comprises:
a uniquely identifiable part; and
a random value part.

21. The method of claim 20, wherein the uniquely identifiable part comprises:
an identifier of an originator of the binary SIP message; and
an identifier of a terminator of the binary SIP message.

22. The method of claim 21, wherein the identifier of the terminator has ten digits by padding ‘F’ right in front of the terminator identifying field number of the binary SIP message.

23. The method of claim 20, wherein the random value of the Via Branch field is a value of the Via Branch field of the binary SIP message.

24. The method of claim 20, wherein the random value of the Call ID field is a value of the Call ID field of the binary SIP message.

25. A method for processing an SIP message in a wireless communications system, the method comprising:
a step in which a calling terminal sends an invite message (INVITE) of a binary SIP message format to a server through an access channel;
a step in which the server decodes the invite message into a text-based SIP message to check the message;
a step in which the server converts the text-based SIP message into an invite message of a binary SIP message and sending the message to a destination terminal through an access channel; and
a step in which the destination terminal sends the calling terminal a response message with respect to the invite message.

26. The method of claim 25, wherein the step in which the calling terminal sets the invite message further comprises:
a step in which the calling terminal starts to set a traffic channel.

27. The method of claim 25, wherein the step in which the destination terminal sets the response message further comprises:
a step in which if the destination terminal has not obtained a traffic channel, the destination terminal starts to set a traffic channel.

28. The method of claim 27, wherein if the destination terminal has not obtained the traffic channel, the response message is sent as a binary SIP message through an access channel.

29. The method of claim 25, wherein the binary message that the server sends to the destination terminal is the same as a binary SIP message that the calling terminal has sent to the server.

30. The method of claim 25, wherein the step of decoding the binary SIP message generates a Via Branch field and a Call ID field by combining fields of the binary SIP message.

31. The method of claim 30, wherein the Via Branch field and the Call ID field, each comprise:
a uniquely identifiable part; and
a random value part.

32. The method of claim 31, wherein the uniquely identifiable part comprises:
an identifier of an originator of the binary SIP message; and
an identifier of a terminator of the binary SIP message.

33. The method of claim 32, wherein the identifier of the terminator has ten digits by padding ‘F’ right in front of a terminator identifying field value of the binary SIP message.

34. The method of claim 31, wherein the random value of the Via Branch field is a Via Branch field value of the binary SIP message.

35. The method of claim 31, wherein the random value of the Call ID field is a value of a Call ID field of the binary SIP message.
